(19) United States
(12) Patent Application Publication
(10) Pub. No.: US 2007/0250887 A1
(43) Pub. Date: Oct. 25, 2007

(54) INTEGRATED BROADCASTING SYSTEM FOR DIGITAL BROADCASTING PROGRAMS

(76) Inventor: Yi-Liang Ting, Taipei (TW)

Correspondence Address: G. LINK CO., LTD, 3550 BELL ROAD, MINOOKA, IL, 60447, US

(21) Appl. No.: 11/382,631

(22) Filed: May 10, 2006

(30) Foreign Application Priority Data
Mar. 21, 2006 (TW) 095109525

(51) Int. Cl. H04N 7/173

(52) U.S. Cl. 725/110; 725/109; 725/87; 725/86

(57) ABSTRACT

The present invention provides an integrated broadcasting system for digital broadcasting programs, comprising: a broadcasting server, a VOD (Video On Demand) server and user players. The broadcasting server broadcasts the digital broadcasting programs in accordance with preset broadcasting schedule. The VOD server stores the backups of digital broadcasting programs broadcasted during previous time and further processes and responds to the requests from user players. The user players receive and play the digital broadcasting programs in strict accordance with the schedule. Also, the user players can transmit requests to the VOD server for enabling the user players to replay the programs specified by the user players. Consequently, the user players can receive the digital broadcasting programs following the schedule and receive the specified programs by means of Time-shift as well.

### FIELD OF THE INVENTION

The present invention relates to an integrated broadcasting system used for TV (television) broadcasting on Internet, especially for digital broadcasting program, which integrates IP TV and VOD (Video On Demand) serve.

### BACKGROUND OF THE INVENTION

Existing IP TV serve adopting Video Broadcasting which employs the art of network IP multicast is especially suitable for a large number of audiences because it can transmit one data flow of each program to unlimited audiences. Existing VOD serve allows audiences to choose programs on demand, and each chosen program requires different bit stream of video. That may cause problems of integrating and how to integrate in inexpensive way if the said two serves are called for integration because of their distinct characteristics.

The IP TV stations owned by different servers broadcast programs in accordance with their own preset broadcasting schedules. As for an audience, he or she has to own a video recorder (machine) that can record a second program while playing a first program if he or she wants to watch more than one program being in face of so many IP TV servers and programs. However, the audience must entail a great expense because of the hard disk or CD/DVD burner equipped in this kind of video recorder.

### SUMMARY OF THE INVENTION

The main object of the present invention is to provide an integrated broadcasting system for digital broadcasting programs, which integrates IP TV serve and VOD serve.

The second object of the present invention is to provide an integrated broadcasting system for digital broadcasting programs, which integrates IP TV serve and VOD serve in inexpensive way.

To achieve the objects mentioned above, the present invention provides an integrated broadcasting system for digital broadcasting programs, comprising: a broadcasting server, a VOD server and user players. The broadcasting server is used for broadcasting the digital broadcasting programs to Internet in accordance with the preset broadcasting schedule. The VOD server is connected to the Internet, and it stores the backups of digital broadcasting programs broadcasted during previous time and further processes and responds to the requests from user players. The user players connected to the broadcasting server and the VOD server via said Internet, can receive and play the digital broadcasting programs in real time and transmit requests to the VOD server via said Internet, wherein said requests are used for enabling the user players to replay the backup programs stored in the VOD server and specified by the user players. Consequently, the user players can receive and play the digital broadcasting programs broadcasted in exactly accordance with the preset broadcasting schedule and receive and play specified backup programs by means of Time-shift as well.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is the structural diagram of integrated broadcasting system for digital broadcasting programs of the present invention;

FIG. 2 is the schematic diagram illustrating the active status between the broadcasting server and the user players of the present invention;

FIG. 3 is the schematic diagram illustrating the active status between the broadcasting server and the VOD server of the present invention;

FIG. 4 is the schematic diagram illustrating the active status between the VOD server and the user players of the present invention; and

FIG. 5 is the schematic diagram illustrating the active status of the user players, the broadcasting server and the VOD server.

### DETAILED DESCRIPTION OF THE INVENTION

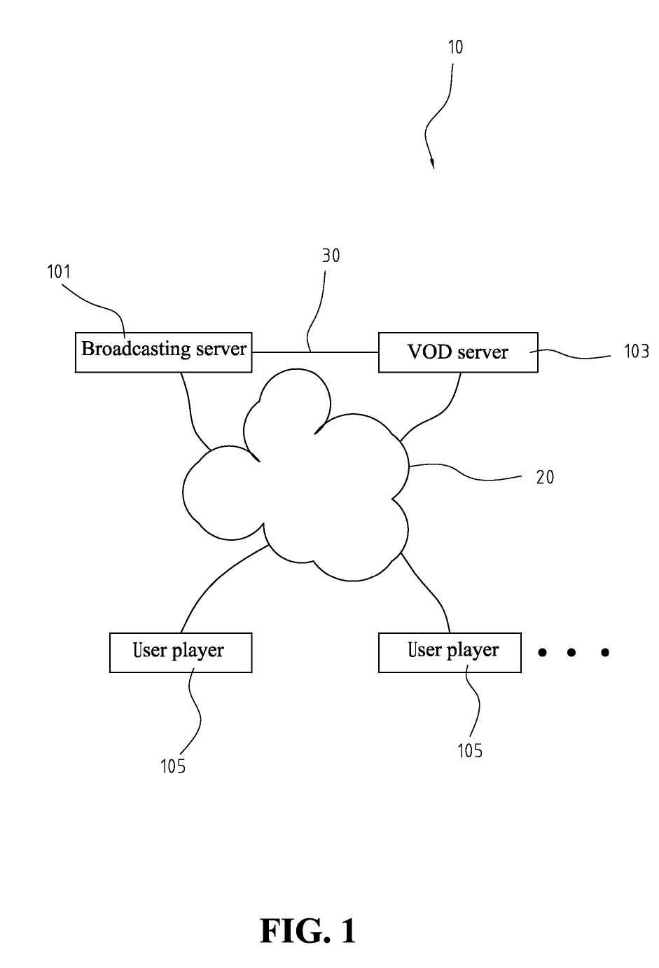

FIG. 1 is the structural diagram of integrated broadcasting system for digital broadcasting programs of the present invention. The integrated broadcasting system for digital broadcasting programs 10 integrates IP TV serve and VOD serve to an integrated broadcasting system, which enables the audiences not only to watch the digital broadcasting programs in real time via Internet but also to watch the digital broadcasting programs of previous time.

The integrated broadcasting system 10 comprises at least one broadcasting server 101, at least one VOD server 103 and user player 105 connected via Internet 20. The primary function of broadcasting server 101 is to broadcast the digital broadcasting program 1011 of the moment on Internet 20 in accordance with the preset broadcasting schedule. And the pertinent technology means of existing IP TV serve can be adopted to perform the broadcasting server 101. In general, all the technology means of existing IP TV serve can be adopted in the present invention. For example, it connects the user players 105 and broadcasting server 101 via URL (Uniform Resource Locator) to receive the digital broadcasting programs 1011 broadcasted by the server 101 in accordance with the preset broadcasting schedule in the existing IP TV serve.

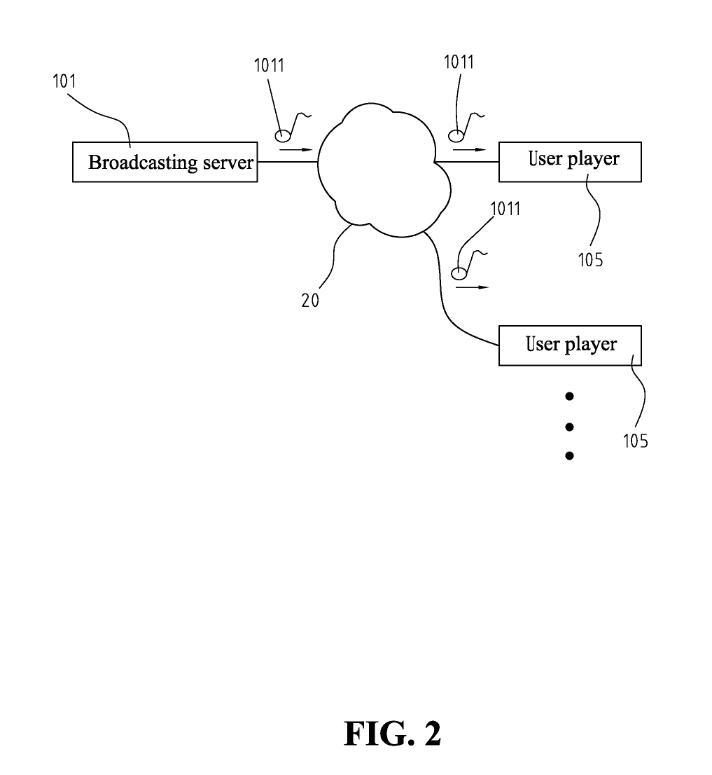

FIG. 2 is the schematic diagram illustrating the active status between the broadcasting server and the user players of the present invention. Each user player 105 receives and plays digital broadcasting programs 1011 in real time from broadcasting server 101 via Internet 20.

The VOD server 103 is connected to Internet 20, and stores the backups of the programs 1011 broadcasted of previous time. And the primary function of said VOD server 103 is to store the digital broadcasting programs 1011 which are already broadcasted, and provide the user players with the said broadcasting programs 1011.

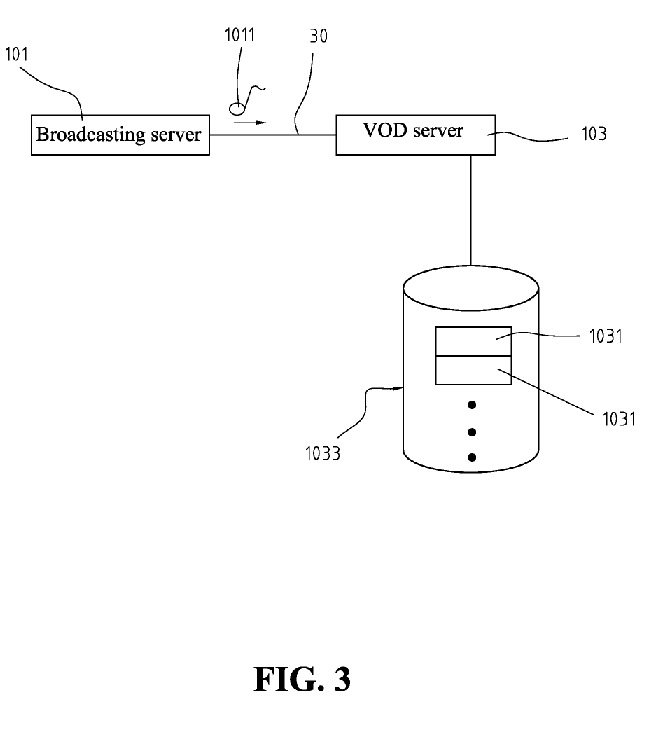

FIG. 3 is the schematic diagram illustrating the active status between the broadcasting server and the VOD server of the present invention. In the embodiment of FIG. 3, VOD server 103 is connected to broadcasting server 101 via the network chain 30, and it can receive each digital broadcasting program 1011 continuously broadcasted by the server 101 then store the received digital broadcasting programs 1011 as its corresponding backup programs 1031 which are stored in the local storage 1033 of the VOD server 103.

The network chain 30 connected only between the broadcasting server 101 and the VOD server 103 can adopt either LAN (local area network) or Internet.

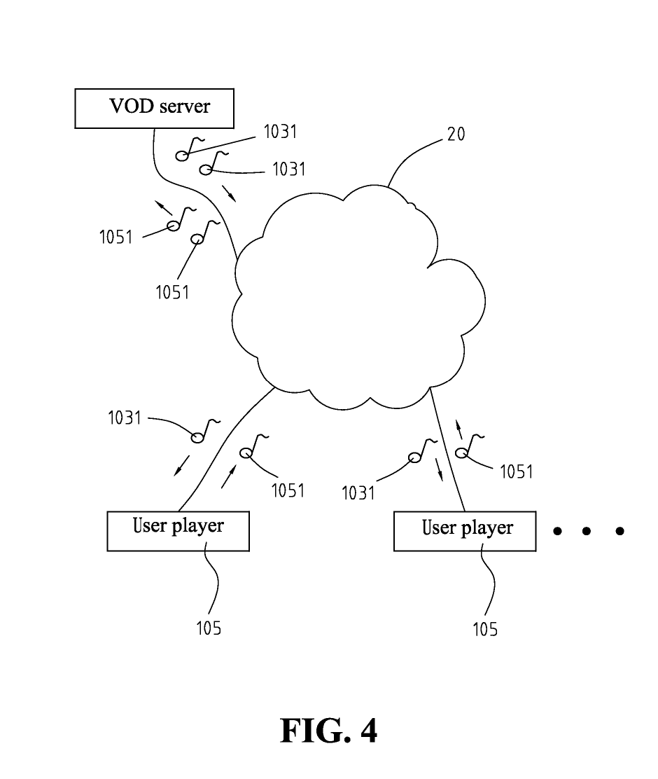

FIG. 4 is the schematic diagram illustrating the active status between the VOD server and the user players of the present invention. Each user player 105 can be connected to VOD server 103 via Internet 20, adopting the technology means of URL, for example. The audience of each user player 105 can transmit at least one request 1051 to VOD server 103 via Internet 20. A function of the request 1051 is to enable the audience to replay the digital broadcasting program that is already broadcasted during previous time (e.g. 15 minutes ago). VOD server will process the requests 1051 after it's received, Then the VOD server will search for the specified program in the backup programs 1031 according to the specifying conditions in request 1051, for example, which channel, which program, which segment of a program (e.g. the segment between the time of the moment and 30 minutes ago), which period of time, etc. And following comes to download the specified backup program 1031 according to request 1051 to user player 105.

VOD server 103 can further store the play list backup in accordance with the preset broadcasting schedule, and the VOD server 103 can keep watch on all the broadcasting programs of the broadcasting server 101 so as to search the specified program according to request 1051 accurately and swiftly.

It can adopt pertinent technology means of existing VOD serve and digital video & audio recording to perform the VOD server 103 in the present invention.

Each user player 105 is connected to broadcasting server 101 and VOD server 103 via Internet 20. Either computer or set-top box can be adopted to perform the user player 105 in the present invention. And the user player 105 can avoid being equipped with mass storage device (e.g. hard disk, CD/DVD burner) because the VOD server 103 can automatically store the backups of digital broadcasting programs 1011 broadcasted by broadcasting server 101. That decreases the manufacturing cost of the user player 105. As for the audience of user player 105, he or she may watch the digital broadcasting programs 1011 at the time as he or she wishes; furthermore, the audience doesn't have to purchase expensive digital devices for watching restrictions.

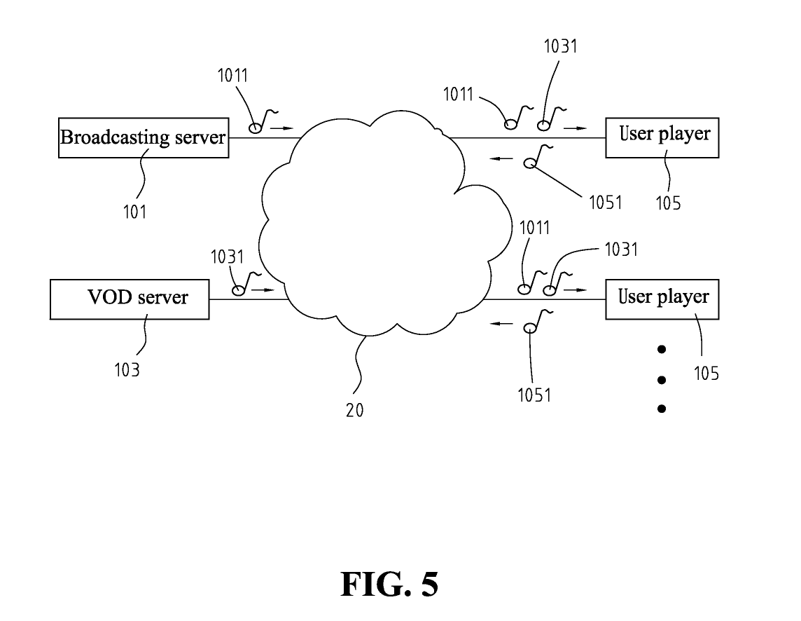

FIG. 5 is the schematic diagram illustrating the active status of the user players, the broadcasting server and the VOD server. Each user player 105 receives the digital broadcasting program 1011 from broadcasting server 101 of the moment, meanwhile, the audience is able to operate the player 105 to transmit request 1051 to the VOD server 103. The VOD server 103 transmits the specified backup program 1031 based on the request 1051 to the user player 105.

The embodiment of the digital broadcasting programs 1011 mentioned above may be digital broadcasting television programs, digital broadcasting audio programs, etc.

The broadcasting server 101 shown in FIG. 1,2,3,5 and the VOD server 103 shown in FIG. 1,3,4,5 are both set to be one for the sake of being easily understood, but it's not limited to that. Those skilled in the art can determine the amount of broadcasting server 101 and VOD server 103 depending on the scale of the integrated broadcasting system 10. And these variations are intended to be within the scope of the invention.

Existing technology means for Bit Stream Transmitting can be adopted in the broadcasting server 101 and the VOD server 103 of the present invention, by means of which the digital broadcasting program 1011 and the program backup 1031 could be downloaded to the user player 105.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An integrated broadcasting system for digital broadcasting programs, comprising:
a broadcasting server, broadcasting digital broadcasting programs to Internet in accordance with preset broadcasting schedule;
a VOD (Video On Demand) server connected to said Internet, which stores the backup programs which are corresponding to said digital broadcasting programs broadcasted during the previous time and further processes and responds to the requests from at least one user player; and
said user players, connected to said broadcasting server and said VOD server via said Internet, which receives and plays the digital broadcasting programs in real time via said Internet from said broadcasting server and transmits requests to said VOD server via said Internet,
wherein said requests are used for enabling said user players to replay the backup programs stored in said VOD server and specified by said user players.

2. The integrated broadcasting system claimed in claim 1, wherein said VOD server is connected to said broadcasting server via a network chain, receiving and storing each said digital broadcasting program broadcasted by said broadcasting server via said network chain and further stores said digital broadcasting programs as corresponding backup programs.

3. The integrated broadcasting system claimed in claim 2, wherein said network chain is chosen form LAN or said Internet.

4. The integrated broadcasting system claimed in claim 1, wherein said VOD server further stores the play list backup in accordance with said preset broadcasting schedule.

5. The integrated broadcasting system claimed in claim 1, wherein said digital broadcasting programs are digital broadcasting television programs.

6. The integrated broadcasting system claimed in claim 1, wherein said digital broadcasting programs are serial bit stream data.

7. The integrated broadcasting system claimed in claim 1, wherein said digital broadcasting programs are digital broadcasting audio programs.

8. The integrated broadcasting system claimed in claim 1, wherein said VOD server is used for storing said digital broadcasting programs already broadcasted by said broadcasting server and providing said user players with said broadcasted digital broadcasting programs.
